(19) United States
(12) Patent Application Publication
(10) Pub. No.: US 2009/0243886 A1
(43) Pub. Date: Oct. 1, 2009

(54) Arrangement Comprising a Vehicle Component and at Least One Electroacoustic Transducer, Especially an Ultrasonic Transducer

(76) Inventors: Peter-Christian Eccardt, Rottach-Egern (DE); Stephan Heinrich, Pfeffenhausen (DE); Heinz Herbrik, Obertraubling (DE); Karsten Hofmann, Pettendorf (DE); Armin Hollstein, Regensburg (DE); Denny Schädlich, Neustadt (DE); Rudolf Thurn, Pressath (DE); Alexander von Jena, München (DE)

Correspondence Address: COHEN, PONTANI, LIEBERMAN & PAVANE LLP, 551 FIFTH AVENUE, SUITE 1210, NEW YORK, NY, 10176, US

(21) Appl. No.: 12/088,095

(22) PCT Filed: Sep. 26, 2006
(86) PCT No.: PCT/EP2006/066770

§ 371 Date: Aug. 18, 2008

(30) Foreign Application Priority Data
Sep. 27, 2005 (DE) 10 2005 046 173.5

(51) Int. Cl. B60Q 1/48

(52) U.S. Cl. 340/932.2

(57) ABSTRACT

Presented is an apparatus that includes a vehicle component that includes an outer wall that includes an internal face and at least one electro-acoustic transducer disposed on the internal face of the outer wall of the vehicle component. The at least one electro-acoustic transducer includes a pot-type housing and a piezo-electric ceramic body disposed inside the pot-type housing. The pot-type housing includes a base area affixed to the internal face of the outer wall of the vehicle component.

The invention relates to an arrangement with a vehicle component and at least one electro-acoustic transducer, in particular an ultrasonic transducer, which is arranged on an internal face of an outer wall of the vehicle component. In addition, the invention also relates to a vehicle with such an arrangement.

Modern vehicles are designed with ‘park assist’ systems which generally include a plurality of ultrasonic sensors which are, for example, arranged in the front and rear fenders of the vehicle. For this purpose, these fenders or alternatively even cover plates, are provided with openings into which the sensors are built. A disadvantage of this is that these sensors have a detrimental effect on the visual impression of the design. Over and above this, the sensors must be painted in the color of the vehicle, which results in a greater manufacturing cost. In doing this it is often relatively difficult to realize a uniform paint finish, and hence an exact color match. Not least, this open arrangement of the sensors, which can be accessed from outside, can also result in the occurrence of damage or deposits of dirt which have a detrimental effect on the functional efficiency.

For this reason, efforts are made to install the ultrasonic transducer where it is covered by the outer wall of the bodywork, so that openings are no longer necessary and the sensors are not visible from outside. A covered installation of the ultrasonic sensors means that they are largely protected from damage from outside.

The installation of an electro-acoustic transducer on the internal face of an outer wall of a vehicle component is known from DE 42 38 924 A1. The electro-acoustic transducer includes a piezo-electric ceramic body which is attached to this internal face by means of an electrically conductive adhesive. A disadvantage of this embodiment is that the ultrasonic sensor consists solely of a piezo-ceramic body which, of itself, has disadvantageous acoustic characteristics. Above all, its transmission sensitivity and receiving sensitivity are in general too low for use as a parking aid, and the radiation characteristics and angular distribution of the ultrasonic waves emitted are not suitable for the recognition of obstacles. The construction proposed in this state of the art requires that the outer wall of the vehicle component, to which the piezo-ceramic is affixed, takes on an active role as a vibrating membrane and/or as an adaptive layer to the air as the propagation medium, in order thereby to achieve the required acoustic characteristics for use as a parking aid. However, with the material properties of the familiar outer walls of vehicles, it is relatively difficult to achieve the required acoustic vibration characteristics for the laminate of piezo-ceramic and vehicle outer wall.

Another arrangement of an electro-acoustic transducer on an internal face of a vehicle component is known from JP10-123236.

Hence, the objective of the present invention is to arrange a vehicle component and an electro-acoustic transducer in a mounting behind a wall in such a way that the electro-acoustic transducer can be mounted at low cost, and reliable operation of the electro-acoustic transducer can be guaranteed.

This objective is achieved by arrangements which have the characteristics as in claim 1 or 17, together with a vehicle which has the characteristics as in claim 33.

An arrangement in conformity with a first aspect of the invention includes a vehicle component and at least one electro-acoustic transducer, in particular an ultrasonic transducer, which is arranged on an internal face of an outer wall of the vehicle component. The electro-acoustic transducer includes a pot-type housing in which is arranged a piezo-electric ceramic body, where the pot-type housing has a base area and this base area is affixed to the internal face of this outer wall of the vehicle component. This arrangement ensures that it is possible to affix the electro-acoustic transducer behind a wall, and the explicit embodiment of the electro-acoustic transducer guarantees secure and reliable operation even when so arranged behind a wall.

The piezo-electric ceramic body is preferably arranged in the interior of the housing, on its base area, in particular is glued onto it. This enables the piezo-electric ceramic body to be arranged in a stable position in the pot-type housing. By this means too, the functioning of the electro-acoustic transducer can be affected positively.

The pot-type housing is preferably designed as a hollow cylinder, having a sidewall which is in the shape of a hollow cylinder which opens out onto the base area. In this form of embodiment the hollow cylinder-shaped sidewall completely surrounds the piezo-electric ceramic body which is arranged on the base area in the interior of the housing. The hollow cylinder-shaped sidewall is preferably in the form of a homogeneous closed sidewall. The piezo-electric ceramic body is preferably designed as a wafer. The laminate comprising the face termination of the pot-shaped housing, formed by its base area, and the piezo-ceramic wafer essentially forms the vibrating membrane of the electro-acoustic transducer. For the purpose of achieving particular acoustic characteristics, the sidewall of the pot-type housing can have reinforcements by variations in the wall thickness on its inner and/or outer side. Hence the housing is not necessarily rotationally symmetrical and can, for example, also have an oval or elliptical shape.

It is advantageous if the pot-shaped housing is designed to be open on the side opposite to the base area. Preferably, this housing will be designed to be open over the entire cross-section of this end region. The interior of the pot-shaped housing will preferably be at least partly filled up with a material. Here, provision can be made to fill up the interior of the pot-shaped housing with potting resin or a foam. Electrical signal wires, for contacting the piezo-electric ceramic body, can be led into the interior space of the housing and in particular integrated into the material with which this interior space is filled.

It is preferable if the thickness of the base area is less than the thickness of the sidewall of the pot-type housing. The wall thickness of this sidewall is thus greater than that of the base area. By this means too, not only can the mechanical strength be optimized, but so also can the acoustic coupling.

It is advantageous if the entire area of the outer side of the base area lies against the internal face of the outer wall of the vehicle component. The attachment and acoustic coupling is thereby effected particularly well.

The electro-acoustic transducer can be affixed irremovably to the internal face of the outer wall of the vehicle component. In doing this, provision can be made that the electro-acoustic transducer is irremovably attached by means of an adhesive layer. For example, a silicon adhesive or polyurethane adhesive could be used as the adhesive. It is preferable if the irremovable attachment is realized by means of an epoxy adhesive. This guarantees, on the one hand, a particularly good attachment, and significantly improved sound penetration through the outer wall of the vehicle component.

Provision can also be made that the electro-acoustic transducer is arranged on the internal face of the outer wall of the vehicle component so that it is removable. An embodiment of this type enables the electro-acoustic transducer to be exchanged quickly and at relatively low cost if it has a defect. The electro-acoustic transducer can be affixed to the internal face of the outer wall by means of a holding device. This holding device can also have a pot-shaped construction, and be designed to accept the electro-acoustic transducer. Here too, provision can be made for the holding device to have an opening through which the electro-acoustic transducer can be introduced and positioned. It is preferable if the holding device is designed to be elastic at least in some areas, to ensure that the electro-acoustic transducer can both be introduced and also subsequently fixed. Spring elements or suchlike can also be provided as the holding device. A latching device with latching elements could also be constructed. Here, it is possible in each case to use the best possible embodiment for the arrangement concerned, depending on the situation and location.

It is preferable if the holding device can be integrated into the vehicle component. This embodiment means that it is always possible to ensure the exact positioning and correct arrangement of the electro-acoustic transducer. By this means too, the assembly can be speeded up. Not least, with this embodiment it is also no longer necessary to attach the holding device in a separate assembly step, so that the assembly can also be carried out more rapidly. In particular in the case when the holding device is at least partly made of plastic it is possible to realize the holding device and at least a partial area of the vehicle component, which can also be made of plastic, as an injection molding.

An elastic coupling layer can be arranged between the base area and the internal face of the outer wall of the vehicle component. This can preferably be in a non-adhesive form. However, provision can also be made for it to be constructed with at least one adhesive side. This coupling layer can be made, for example, from silicon, silicon gel, vulcanized elastomer or thermoplastic elastomer. Due to their elastic material characteristics, these materials permit a very close form-fit, and thereby also a very good acoustic coupling. Using the holding device, which can also be designed as a snap-fit device, the electro-acoustic transducer is pressed onto the elastic coupling layer, which is preferably non-adhesive, and hence is also held onto the internal face of the outer wall of the vehicle component. The coupling layer will preferably have a thickness between about 0.001 mm and about 3 mm. These values are preferred and advantageous in the case of a typical electro-acoustic transducer diameter of about 25 mm.

Provision can also be made that the base area of the pot-type housing is removably affixed to the internal face of the outer wall of the vehicle component solely by means of a two-sided adhesive acoustic coupling tape. With this form of embodiment, an additional holding device is not necessary. On the one hand, the base area or outer side of the base area is stuck onto this adhesive tape, and on the other hand it ensures the attachment to the inner face of the outer wall. An example of such a two-sided adhesive tape which can be used is a tape of type VHB from 3M. These adhesive tapes have very good sound transmission and in addition have a very good adhesive strength combined with good resistance to relatively extreme environmental influences, such as for example very severe temperature fluctuations. The thickness of this two-sided adhesive tape will preferably be between about 0.001 mm and about 3 mm. In spite of the very strong adhesive effect, the joint can if necessary be released again by tilting the transducer sideways, for example with the aid of a tool. This tilting applies strong notching forces to the adhesive joint, which results in the loosening of the joint. In normal operation of the ultrasonic sensor, such notching forces cannot arise, so that the adhesive tape ensures a reliable and long-lasting attachment.

The pot-type housing is preferably constructed as a metal housing. In principle, it is possible to use any metal or any metal alloy. Preferably, the embodiment will be of aluminum or die-cast aluminum. This ensures adequate mechanical stability combined with relatively low weight. Over and above this, the vibrating membrane of the electro-acoustic transducer can also be optimally designed.

An arrangement conforming to a second aspect of the invention includes a vehicle component and at least one electro-acoustic transducer, in particular an ultrasonic transducer, which is arranged on an internal face of an outer wall of the vehicle component. The electro-acoustic transducer is arranged removably on the internal face of the outer wall of the vehicle component, and an acoustic coupling element is arranged between the electro-acoustic transducer and the internal face. Apart from simple and reversible assembly, in particular when the transducer is replaced, it is possible to ensure the reliable functioning of the transducer, because even with this behind-wall mounting it is possible to ensure optimal acoustic transmission.

It is preferable if the electro-acoustic transducer can be affixed to the internal face of the outer wall by means of a holding device. Provision can be made that the holding device is integrated into the vehicle component.

It is preferable if a non-adhesive elastic acoustic coupling layer is arranged between the electro-acoustic transducer and the internal face of the outer wall. This layer can also be constructed to be adhesive on at least one side. The acoustic coupling layer will preferably have a thickness of between about 0.001 mm and about 3 mm.

Provision can also be made that the electro-acoustic transducer is removably affixed to the internal face of the outer wall of the vehicle component solely by means of a two-sided adhesive acoustic coupling tape. The thickness of the coupling tape will preferably be between about 0.001 mm and about 3 mm.

The electro-acoustic transducer will preferably include a pot-type housing, in which is arranged a piezo-electric ceramic body, where the pot-type housing has a base area which is removably affixed to the internal face of the outer wall of the vehicle component. The advantageous embodiments of the electro-acoustic transducer cited for the first aspect of the invention, in particular of the pot-type housing, should also be regarded as advantageous embodiments for the second aspect of the invention.

However, in the second aspect of the invention, the electro-acoustic transducer can also be designed in diverse ways, and is not limited to a pot-type embodiment. In principle, all transducer embodiments can be provided. For example, this also includes so-called laminated ultrasonic transducers, such as are described in EP 0 425 716 B1 for example.

Another aspect of the invention is based on the recognition that an increase in the wall thickness for the transducer pot, in particular in the hollow cylindrical region, or an enhancement of the mechanical bracing of the transducer in the region of the base area or the front of the transducer in the appropriate edge zones, as applicable, has the effect of stiffening this partial area of the transducer, and hence the excitation of plate vibrations is markedly reduced. In relation to the plate vibrations, the following is noted. With a covered form of installation, the ultrasonic transducers are accommodated, for example, in depressions within the fender. The difference from an uncovered installation, which brings with it significant differences in the characteristics of the systems, is due to the fact that the plastic material of fenders is excited to undefined vibrations, so-called plate vibrations. From this, there result sound fields which, because of strong interfering noise, do not permit any of the object space monitoring which would meet the requirements of a parking aid. Edge vibrations from the electromechanical transducer, which arise with normal modes of operation and an uncovered installation, play no significant role with conventional transducers. The plate vibrations cited arise when the edge movements of the transducer are introduced into the fender. These generate plate vibrations or planar modes, as applicable, with numerous deflections which produce acoustic effects with the same and the opposite phases. This aspect of the invention thus enables the excitation of plate vibrations to be markedly reduced and an ultrasonic transducer to be provided, for use in a covered installation, the efficiency of which is arranged to be optimal for object space monitoring through the appropriate cover.

In connection with this, one solution provides that, relative to the internal diameter of the pot in the region behind the ultrasonic transducer, a minimum size of wall thickness is realized for the pot. At the same time, an upper limit is to be specified for this ratio, because from a certain value of this numeric ratio no further increase in the effectiveness is to be expected. The ratio of the wall thickness of the pot to the internal diameter of the pot is from about 0.2 up to a maximum of 2.

Another solution provides that the wall thickness of a ring, located outside the pot wall and with a space between them, is related to the external diameter of the pot. When present this ring acts as a damping ring, it terminates flush with the front of the transducer or the base area, as applicable, and is arranged concentrically with the hollow cylindrical part of the transducer and parallel to it, and is spaced away from the actual pot wall.

The space is ideally in the form of an annular gap. This annular gap has a maximum width of 1 mm. The ratio of wall thickness for the damping ring to the external diameter of the pot is about 0.1 up to a maximum of 2.

An advantageous embodiment provides for the simultaneous use of a reinforced pot wall of a damping ring.

In connection with the reinforced pot wall it should be noted that for the common flexural ultrasonic transducers the typical wall thicknesses are from about 1 to 2 mm. According to the invention these will be enlarged, for example up to 20 mm or more. The effect of this is that the transducer has significantly smaller deflections at its outer edge, and hence the excitation of plate vibrations is markedly reduced.

The measure of using a damping ring also represents a stiffening of the ultrasonic transducer in the region of its edge, and thereby weakens the basis for it to excite the material of a fender in its edge region. A concentrically arranged metal ring with the wall thicknesses described is preferably made of aluminum, so that plate vibrations which arise in the plastic material of the fender are also reduced. The annular gap provided between the pot and the damping ring has a maximum width of 1 mm and decouples the two components from each other. It is important that the pot and the damping ring are as far as possible decoupled, both in respect of their dimensions and also in respect of time.

The insertion of an intermediate coupling layer is particularly advantageous, because the front of the transducer can be adapted, in terms of various material properties, to the material of a fender, for example.

A vehicle will preferably be equipped with one of the arrangements cited above or an advantageous embodiment thereof. The electro-acoustic transducer can preferably be associated with a driver assistance system, in particular a park assist system. Parking aids can function more precisely by the arrangement, even when mounted behind a wall.

Exemplary embodiments of the invention are described in more detail below by reference to schematic drawings. These show:

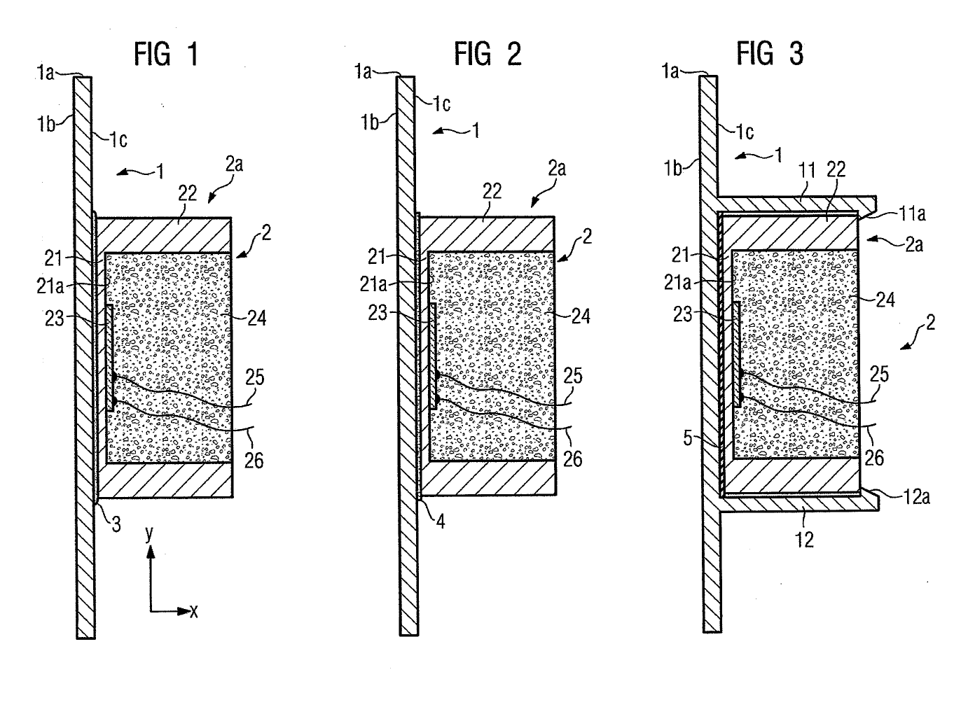

FIG. 1 a sectional view through an arrangement in accordance with a first form of embodiment.

FIG. 2 a sectional view through an arrangement in accordance with a second form of embodiment.

FIG. 3 a sectional view through an arrangement in accordance with a third form of embodiment.

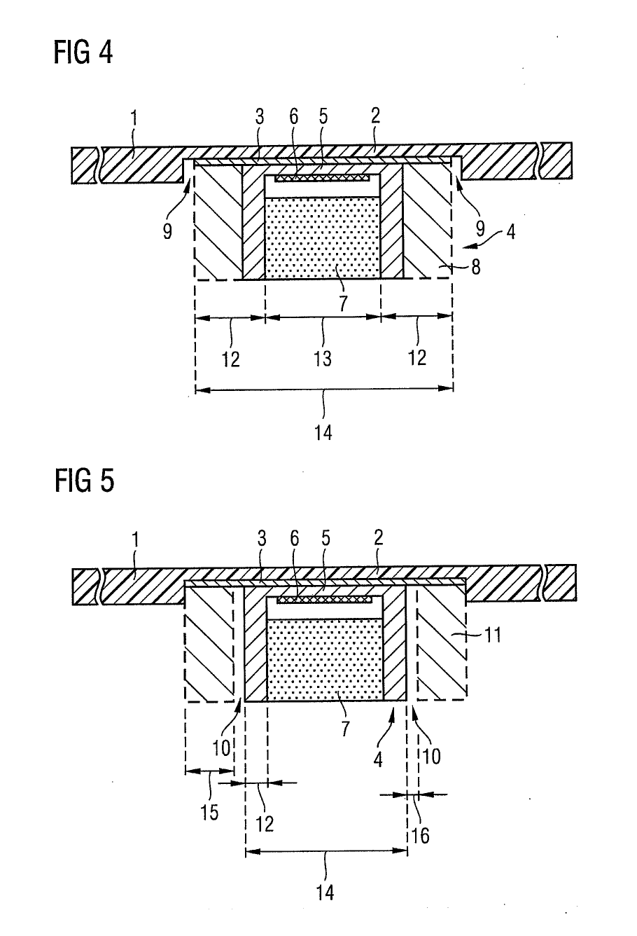

FIG. 4 shows a sectional view of an ultrasonic transducer with a significantly enlarged pot wall in the region to the rear side of the transducer pot, in accordance with another form of embodiment.

FIG. 5 shows the concentric extension of the ultrasonic transducer by an axially decoupled damping ring in accordance with another form of embodiment.

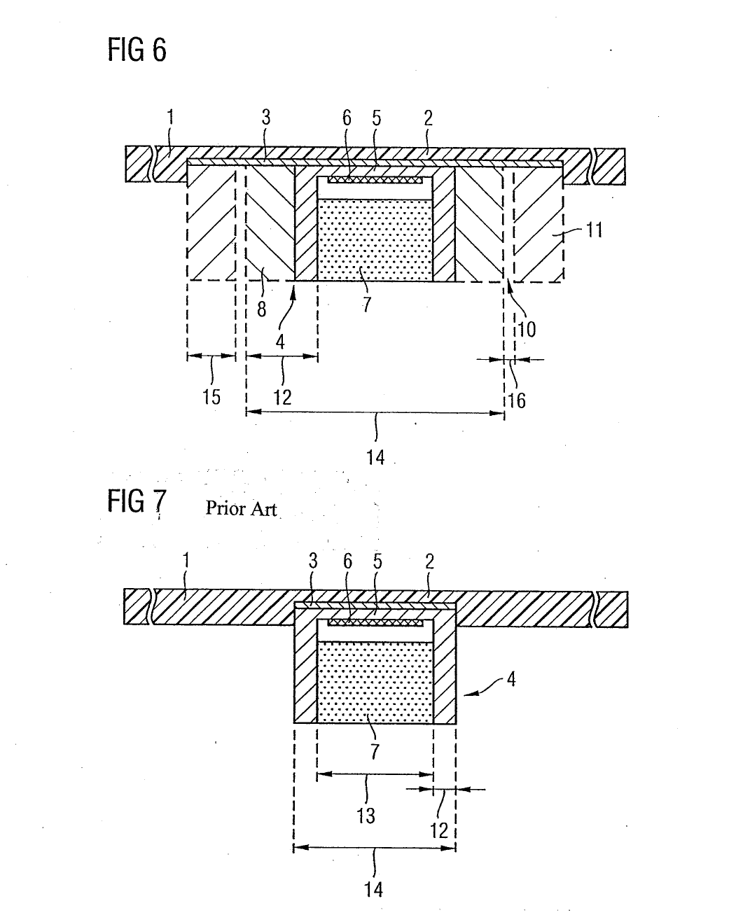

FIG. 6 shows, again as a sectional view, an ultrasonic transducer both with a reinforced pot wall and also with the concentric extension by an axially decoupled damping ring in accordance with another form of embodiment.

FIG. 7 shows an ultrasonic transducer with appropriately thinner wall thickness for the ultrasonic transducer's pot, from which the ultrasonic transducer in FIG. 4 is developed.

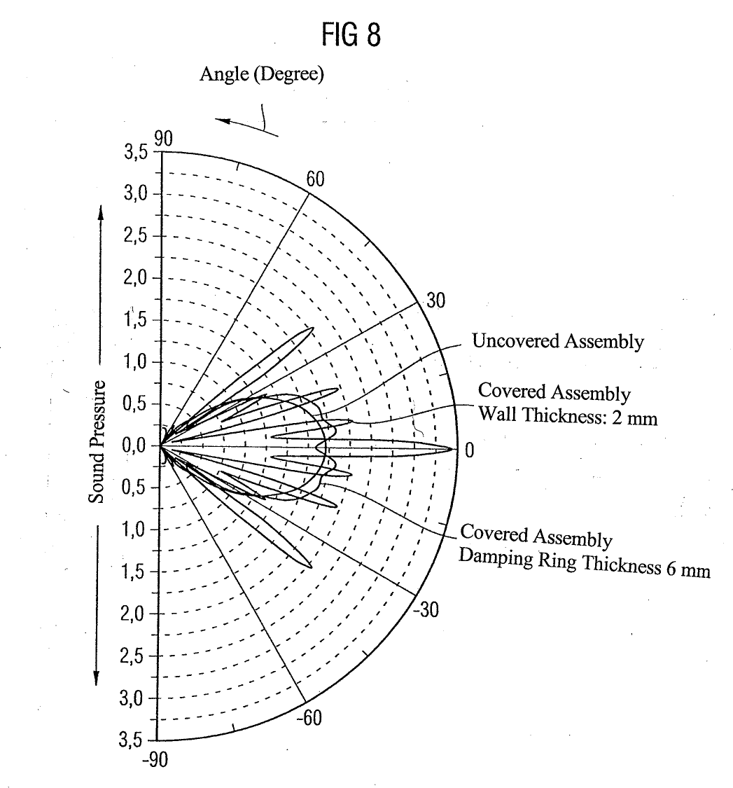

FIG. 8 shows the angle-dependent emission characteristics of an ultrasonic transducer with an increased wall thickness as shown in FIG. 4.

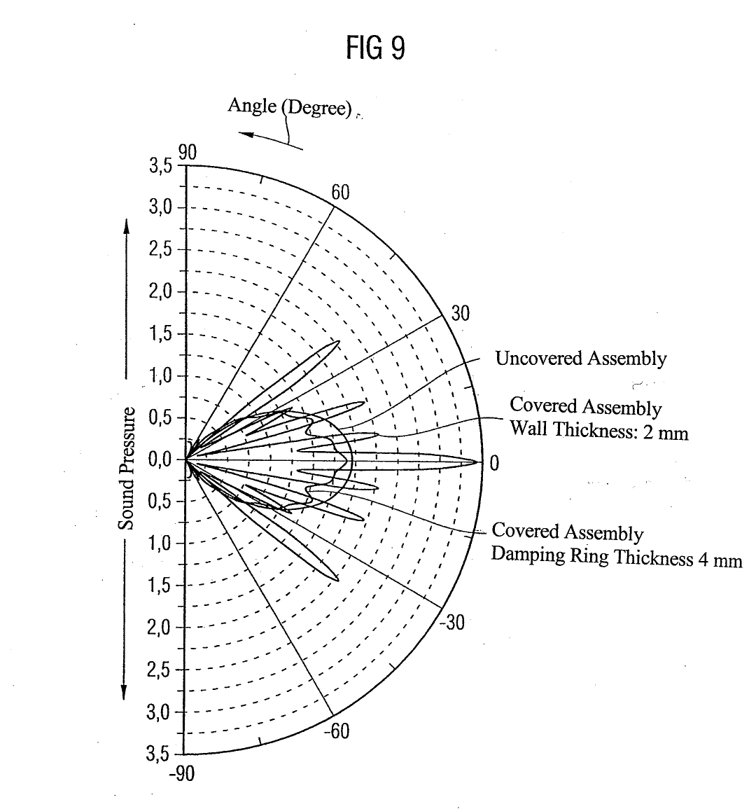

FIG. 9 shows the angle-dependent emission characteristics of an ultrasonic transducer with a damping ring as shown in FIG. 5.

FIG. 1 shows a schematic cross-sectional view of a fender 1, which has an outer wall 1a. This outer wall 1a has an outer face 1b, which is oriented towards the vehicle's external environment. In addition, this outer wall 1a has an internal face 1c, on which the ultrasonic transducer 2 is arranged. This ultrasonic transducer 2 includes a pot-type housing 2a, which in the cross-sectional view has a U-shape. The pot-type housing 2a is constructed as an aluminum die-casting and includes a base area 21 together with a hollow cylinder-shaped sidewall 22. The thickness (dimension in the x-direction) of the base area 21 is significantly smaller than the thickness (dimension in the y-direction) of the hollow cylinder-shaped sidewall 22.

A piezo-electric ceramic body 23 is stuck onto the internal face 21a of the base region 21. As can be seen, in the y-direction this piezo-electric ceramic body 23 extends only partly over the entire inner area of the internal face 21a of the base area 21. Provision can also be made that the dimensions of this piezo-electric ceramic body 23 are sized such that they extend over the entire area of this internal face 21a. The interior region of the pot-type housing 2a is filled up with a filling compound, which in the exemplary embodiment is a casting resin 24. On its side opposite to the base area 21, the pot-type housing 2a is constructed to be completely open, whereby the hollow cylinder-shaped sidewall 22 extends essentially in a straight line in the x-direction. Electrical wires 25 and 26 to the piezo-electric ceramic body 23 are fed through this casting resin 24. The ultrasonic transducer 2 is irremovably joined to the internal face 1c of this outer wall 1a of the fender 1. For this purpose, an adhesive layer 3 is formed, by which the pot-type housing 2a, and hence also the entire ultrasonic transducer 2, is glued onto this internal face 1c across the complete surface of its base area 21.

FIG. 2 shows another exemplary embodiment, again showing a sectional view of the arrangement of the fender 1 and the ultrasonic transducer 2. Unlike the embodiment shown in FIG. 1, in this embodiment the ultrasonic transducer 2 is removably affixed to the internal face 1c of the outer wall 1a of the fender 1. To this end, the base area 21 of the pot-type housing 2a is arranged on the internal face 1c using a two-sided adhesive acoustic coupling tape 4. Here again, the complete surface of the base area 21 or its outer face, as applicable, is stuck onto the adhesive coupling tape 4, and by this is attached across its complete surface to the internal face 1c.

FIG. 3 shows a cross-sectional view in accordance with another embodiment, in which the ultrasonic transducer 2 is held in a steady position on the outside wall 1a by means of a holding device. To this end, fixing brackets 11 and 12 are constructed in one piece with the outer wall 1a. At their unattached ends, these brackets 11 and 12 have a cranked construction, and include retaining lugs 11a and 12a respectively. These land on the hollow cylinder-shaped sidewall 22 and press the ultrasonic transducer 2 against the internal face 1c. Between the base area 21 and the internal face 1c is constructed a non-adhesive elastic acoustic coupling layer 5, which in the exemplary embodiment is constructed with a larger area than the area of the outer face of the base area 21. This coupling layer 5 can also be constructed with an area the same size as or smaller than the area of the outer face of the floor area 21.

The arrangements explained in FIG. 1 to FIG. 3 can be arranged in both a front fender and in a rear fender on a vehicle. The ultrasonic transducers 2 are associated with a driver assistance system, in particular a park assist system. The ultrasonic transducers 2 shown can generally be pre-manufactured and pre-tested, independently of the vehicle outer wall on which they are to be mounted. The acoustic characteristics necessary for such types of park assist systems are satisfied above all in respect of sensitivity and emission characteristics. A particular advantage here is that this is broadly independent of the acoustic characteristics of the outer wall 1a. Hence there are no particular requirements that must be met by this outer wall 1a in respect of its vibratory capabilities, except that it must have the relevant required sound transparency. However, this exists for the common outer walls, at least if the wall thickness is appropriately designed at the mounting site for the ultrasonic transducer 2. For example, to this end a thin-walled recess could be constructed on this outer wall 1a. Hence the outer wall 1a would be of thinner construction in the region of the attachment of the ultrasonic transducer 2.

In the case of all the embodiments, the pot-type housing 2a is designed to be significantly larger than the piezo-electric ceramic body 23. The unattached surfaces of the piezo-electric ceramic body 23 are completely surrounded by the casting resin 24, which completely fills up the interior space in the housing 2a.

In the embodiments shown in FIG. 2 and FIG. 3, in which the ultrasonic transducer 2 is removably attached, any other transducer principle can also be provided. In particular, for example, a laminated electro-acoustic transducer can also be removably attached to the interior face of the outer wall.

In FIGS. 4 to 9, elements which are the same or have the same function are given the same reference marks.

For the explanation of another form of embodiment, we start initially from FIG. 7, which shows an ultrasonic transducer which is partly accommodated in a recess within a fender 1. A coupling layer having the same diameter as the ultrasonic transducer is provided on the fender 1, which preferably consists of plastic, this layer being well bonded on the one side to the fender 1 and on the other side to the base area or front 5 of the transducer, as applicable. The front 5 of the transducer has on its inner side a piezoelectric ceramic body 6 or a piezo-ceramic 6, as applicable, which together with the front 5 of the transducer represents a flexural transducer. Apart from the front of the transducer and the piezo-ceramic, the ultrasonic transducer itself consists of a hollow cylinder-shaped tube which is closed off on one side, at the front, by the front of the transducer. At its rear, the ultrasonic transducer is filled up with a filling compound 7. This filling compound 7 does not generally make contact with the piezo-ceramic. Other reference marks shown in FIG. 7 relate to the internal diameter 13 of the pot, the external diameter 14 of the pot, the wall 4 of the pot, the wall thickness 12 of the pot.

FIG. 4 now shows a construction corresponding to FIG. 7, where the wall thickness 12 of the pot has been significantly increased by a wall reinforcement 8. The pot wall 4 thereby has a wall thickness which is about 0.2 to 2 times as much as the internal diameter 13 of the pot. The coupling layer 3 has an extent which puts the entire front 5 of the transducer in contact with the fender 1 or the plastic layer 2, as applicable. An annular gap 9, which is present between the enlarged pot wall and the surrounding wall of a recess in the fender 1, serves to effect vibratory decoupling, whereby the extended pot wall provides sufficient mechanical rigidity. Hence FIG. 4 can be said in summary to show an ultrasonic transducer for covered installation, consisting on the one hand of a U-shaped pot with a hollow cylinder-shaped pot wall 4 and with a termination on one face which forms the base area or front 5 of the transducer, as applicable, where the opposite end is filled with a filling compound 7, and on the other hand of an electromechanical transducer (piezoceramic 6) attached across a surface to the internal face of the transducer front to form with the transducer front a flexural ultrasonic transducer, where the outer face of the transducer front is coupled to a layer which covers the front side of the ultrasonic transducer and the thickness 12 of the hollow cylinder-shaped pot wall has the following ratio to the internal diameter 13 of the pot:wall thickness of the pot/internal diameter of the pot=approx. 0.2 to 2.

FIG. 5 shows a sectional view of an ultrasonic transducer, with a covered installation, corresponding to another form of embodiment or an alternative solution, as applicable, with a damping ring 11. In this case, the coupling layer 3 in turn extends out to the outermost edge of the attenuating ring 11 which belongs to the transducer. An annular gap 9 such as can be seen in FIG. 1 does not exist in the representation shown in FIG. 5, because the focus is on mechanical rigidity and the distance from the outer perimeter of the damping ring 11 to the flexural ultrasonic transducer is adequately large. The thickness 15 of the damping ring is designed in such a way that it satisfies the following ratio:

ring wall thickness/external diameter 14 of the pot=0.1 to 2. Hence FIG. 5 can be said in summary to show an ultrasonic transducer for covered installation, consisting on the one hand of a U-shaped pot with a hollow cylinder-shaped pot wall 4 and with a termination on one face which forms the front 5 of the transducer, where the opposite end is filled with a filling compound 7, and on the other hand of an electro-mechanical transducer (piezo-ceramic 6) attached across a surface to the internal face of the transducer front 5 to form with the transducer front a flexural ultrasonic transducer, where the outer face of the transducer front is coupled to a layer which covers the front side of the ultrasonic transducer, there is a damping ring, surrounding the hollow cylinder-shaped pot wall 4 concentrically and spaced away from it by an annular gap 10, which terminates flush with the front 5 of the transducer, and the thickness 15 of the damping ring 11 has the following ratio to the external diameter of the pot:wall thickness of the damping ring/external diameter 14 of the pot=approx. 0.1 to 2.

Referring also to the diagram shown in FIG. 6 it can be seen that it is logical to calculate the reinforced pot wall 4 using a specified factor applied to the internal diameter 13 of the pot. To avoid overlaps, the thickness 15 of the damping ring 11 is calculated using a factor applied to the magnitude of the external diameter 14 of the pot, that is taking into account an enlarged or reinforced pot wall. Hence, it is possible that the total external dimensions of an ultrasonic transducer which arise can be significantly over 20 mm. FIG. 6 thus shows an ultrasonic transducer which combines the two specified solutions.

As shown in FIGS. 8 and 9, which are constructed from modeled calculations, the inventive measures illustrated above result in improvements for the emission performance of an ultrasonic transducer in the uniformity of the sound pressure as a function of the angle. This result has been confirmed experimentally with measurements using microphones, where the advantage of using a damping ring is particularly apparent. The broad reproducibility of the transducer characteristics achieved with a covered installation approximates essentially to the system characteristics in the case of uncovered installation. Overall, the damping behavior of an ultrasonic transducer in accordance with the invention has been confirmed in relation to plate vibrations.

In both FIG. 8 and also FIG. 9, the emission characteristic of an ultrasonic transducer with an uncovered installation can be seen as a smoothly curved function. This function, which has a club-shaped symmetry about the horizontal axis, has in both cases a maximum which is roughly the same magnitude.

A change to a covered installation of an ultrasonic transducer with no stiffening applied results in very unsmooth graphs, both in FIG. 5 and in FIG. 6, with several maxima and several minima. This does not give a uniform coverage of an object space.

As shown in FIG. 8, a change to a covered installation with a wall thickness of 6 mm for the ultrasonic transducer's pot produces a curve with greatly attenuated peaks for maxima and minima, which shows a significant improvement in the uniformity of the sound pressure as a function of angle.

FIG. 9 shows the results for the covered installation of an ultrasonic transducer which is surrounded by a 4 mm thick damping ring. The graphs corresponding to an uncovered installation and to a covered installation with wall thickness of 2 mm are identical with those of FIG. 8. The ultrasonic transducer with a covered installation and a 4 mm damping ring generates a graph which again has a shape with a few small maxima and minima, so that from the sound pressure curve it is possible to determine that coverage of the object space is largely uniform and independent of the angle.

FIG. 8 thus shows the effects of the increased wall thickness and FIG. 9 the effects of using a damping ring on the angular dependence of the sound pressure in the far-field.

In closing it is noted that it is also possible to combine the forms of embodiment in FIG. 1, 2 or 3 with the forms of embodiment in FIG. 4, 5 or 6.

1-39. (canceled)

40. An apparatus, comprising:
a vehicle component comprising an outer wall with an internal face; and
at least one electro-acoustic transducer disposed on the internal face of the outer wall of the vehicle component, the at least one electro-acoustic transducer comprising:
a pot-type housing comprising a base area coupled to the internal face of the outer wall of the vehicle component; and
a piezo-electric ceramic body disposed inside the pot-type housing.

41. The apparatus as claimed in claim 40, wherein the at least one electro-acoustic transducer comprises an ultrasonic transducer.

42. The apparatus as claimed in claim 40, wherein the piezo-electric ceramic body is glued on the base area inside the pot-type housing.

43. The apparatus as claimed in claim 40, wherein the pot-type housing comprises a hollow cylinder-shaped sidewall.

44. The apparatus as claimed in claim 40, wherein the piezo-electric ceramic body comprises a wafer.

45. The apparatus as claimed in claim 40, wherein the pot-type housing defines an open form on a side opposite to the base area.

46. The apparatus as claimed in claim 40, wherein the base area has a smaller thickness than the thickness of a sidewall of the pot-type housing.

47. The apparatus as claimed in claim 42, wherein an unattached surface of the piezo-electric ceramic body coupled to the base area is surrounded by a filling material that at least partly fills up the pot-type housing.

48. The apparatus as claimed in claim 40, wherein the base area is coupled across its entire surface to the internal face of the outer wall of the vehicle component.

49. The apparatus as claimed in claim 40, wherein the electro-acoustic transducer is irremovably coupled to the internal face of the outer wall of the vehicle component.

50. The apparatus as claimed in claim 40, wherein the electro-acoustic transducer is removably coupled the internal face of the outer wall of the vehicle component.

51. The apparatus as claimed in claim 50, further comprising a holding device, wherein the electro-acoustic transducer is coupled to the internal face of the outer wall by the holding device.

52. The apparatus as claimed in claim 51, wherein the holding device is integrated into the vehicle component.

53. The apparatus as claimed in claim 51, wherein a non-adhesive elastic acoustic coupling layer is disposed between the base area and the internal face of the outer wall.

54. The apparatus as claimed in claim 53, wherein the acoustic coupling layer has a thickness of between 0.001 mm and about 3 mm.

55. The apparatus as claimed in claim 50, wherein the base area is removably coupled to the internal face of the outer wall of the vehicle component by means of a two-sided adhesive acoustic coupling tape.

56. The apparatus as claimed in claim 55, wherein the thickness of the coupling tape is between 0.001 mm and about 3 mm.

57. An apparatus, comprising:
a vehicle component comprising an outer wall comprising an internal face;
at least one electro-acoustic transducer removably coupled to the internal face of the outer wall of the vehicle component; and
an acoustic coupling element disposed between the at least one electro-acoustic transducer and the internal face of the outer wall of the vehicle component.

58. The apparatus as claimed in claim 57, wherein the at least one electro-acoustic transducer comprises an ultrasonic transducer.

59. The apparatus as claimed in claim 57, further comprising a holding device, wherein the electro-acoustic transducer is coupled to the internal face of the outer wall by the holding device.

60. The apparatus as claimed in claim 59, wherein the holding device is integrated into the vehicle component.

61. The apparatus as claimed in claim 57, wherein the acoustic coupling element comprises a non-adhesive elastic acoustic coupling layer disposed between the electro-acoustic transducer and the internal face of the outer wall.

62. The apparatus as claimed in claim 61, wherein the acoustic coupling layer has a thickness of between 0.001 mm and about 3 mm.

63. The apparatus as claimed in claim 57, wherein the electro-acoustic transducer is removably coupled to the internal face of the outer wall of the vehicle component by a two-sided adhesive acoustic coupling tape.

64. The apparatus as claimed in claim 62, wherein the thickness of the coupling tape is between 0.001 mm and about 3 mm.

65. The apparatus as claimed in claim 57, wherein the electro-acoustic transducer comprises:
a pot-type housing comprising a base area removably coupled to the internal face of the outer wall of the vehicle component; and
a piezo-electric ceramic body disposed inside the pot-type housing.

66. The apparatus as claimed in claim 65, wherein the piezo-electric ceramic body is glued on the base area inside the housing.

67. The apparatus as claimed in claim 65, wherein the pot-type housing comprises a hollow cylinder-shaped sidewall.

68. The apparatus as claimed in claim 65, wherein the piezo-electric ceramic body comprises a wafer.

69. The apparatus as claimed in claim 65, wherein the pot-type housing defines an opening on a side opposite to the base area.

70. The apparatus as claimed in claim 67, wherein the base area has a smaller thickness than the thickness of the sidewall of the pot-type housing.

71. The apparatus as claimed in claim 66, wherein unattached surfaces of the piezo-electric ceramic body coupled to the base area are surrounded by a filling material that at least partly fills up the pot-type housing.

72. The apparatus as claimed in claim 65, wherein the base area is coupled across its entire surface to the internal face of the outer wall of the vehicle component.

73. The apparatus as claimed in claim 65, wherein the vehicle component comprises a fender.

74. The apparatus as claimed in claim 40, wherein the pot-type housing comprises a hollow cylinder-shaped pot wall and a face closure which forms the base area, and wherein the ratio of the thickness of the hollow cylinder-shaped pot wall to the internal diameter of the pot-type housing is 0.2 to 2.

75. The apparatus as claimed in claim 40, wherein the pot-type housing comprises:
a hollow cylinder-shaped pot wall;
a face closure which forms the base area; and
a damping ring which terminates flush with the base area and surrounds the hollow cylinder-shaped pot wall concentrically and spaced from that cylinder-shaped pot wall by an annular gap;
wherein the ratio of the thickness of the damping ring to the external diameter of the pot-type housing is 0.1 to 2.

76. The apparatus as claimed in claim 74, wherein an end of the pot-type housing opposite to the base area is filled with a filling compound.

77. The apparatus as claimed in claim 74, further comprising a damping ring, and wherein the pot wall is reinforced.

78. The apparatus as claimed in claim 75, wherein the width of the annular gap between the pot wall and the damping ring is a maximum of 1 mm.

79. The apparatus as claimed in claim 75, wherein the damping ring comprises aluminum.

80. A vehicle, comprising:
an apparatus as claimed in claim 40, the electro-acoustic transducer being associated with a driver assistance system.

81. The vehicle as claimed in claim 80, wherein the driver assistance system comprises a park assist system.
